(19) United States
(12) Patent Application Publication
(10) Pub. No.: US 2019/0259095 A1
(43) Pub. Date: Aug. 22, 2019

(54) DETERMINING PRESENT AND FUTURE VIRTUAL BALANCES FOR A CLIENT COMPUTING DEVICE

(71) Applicant: Southwest Business Corporation, San Antonio, TX (US)

(72) Inventor: Andrew Templeton, Austin, TX (US)

(73) Assignee: Southwest Business Corporation, San Antonio, TX (US)

(21) Appl. No.: 16/280,794

(22) Filed: Feb. 20, 2019

Related U.S. Application Data
(60) Provisional application No. 62/632,876, filed on Feb. 20, 2018.

(51) Int. Cl. G06Q 40/02; G06N 3/02; G06N 7/08; G06N 7/00

(52) U.S. Cl. CPC G06Q 40/02; G06N 7/005; G06N 7/08; G06N 3/02

(57) ABSTRACT

A method of predicting a future balance of an account involves obtaining an initial balance of the account at the first time, and a stochastic projection model that was developed based on a set of prior transactions associated with the account. The stochastic projection model may model past financial transaction data associated with the account as Geometric Brownian Motion, for example. Based on the stochastic projection model, the method involves estimating a future account balance, or a range of potential account balances within a confidence threshold. The predicted future account balance may be used to detect overspending events, indicate whether or not a user can afford to make a particular purchase, and/or otherwise inform an entity the extent of likely future spending.

### CROSS-REFERENCE TO RELATED APPLICATIONS

This application claims the benefit of U.S. Provisional Application No. 62/632,876, filed Feb. 20, 2018, which is hereby expressly incorporated by reference herein.

### FIELD OF THE TECHNOLOGY

At least some embodiments disclosed herein relate to managing data records in computing systems in general, and more particularly, but not limited to, managing data records to determine present and future virtual balances of an account, and/or operating a user interface of a client computing device that communicates with the cloud platform and/or other computing device.

### BACKGROUND

The Automated Clearing House (ACH) is an electronic network for financial transactions in the United States. More specifically, the ACH is a computer-based clearing and settlement facility established to process the exchange of electronic transactions between participating depository institutions. Regulations that govern the ACH network are established by NACHA and the Federal Reserve. The Federal Reserve Banks, through the FedACH system, are collectively ACH operators.

The Federal Reserve Banks process some of the commercial interbank ACH transactions, and other transactions are processed by the Electronic Payments Network (EPN), which is a private-sector ACH operator in the United States. EPN and the Reserve Banks rely on each other for the processing of certain transactions when either party to the transaction is not their customer. These interoperator transactions are settled by the Reserve Banks.

The ACH processes large volumes of credit and debit transactions. For example, ACH credit transfers include direct deposit, payroll and vendor payments. ACH direct debit transfers include consumer payments on insurance premiums, mortgage loans, etc. Businesses increasingly use ACH for customer payments, instead of using credit or debit cards.

### SUMMARY OF THE DESCRIPTION

Described herein is technology for, among other things, systems and methods to (i) manage data stored on cloud platform/computing device(s) and/or an associated client computing device, and/or to (ii) manage a user interface of the client computing device regarding such data management. Some embodiments are summarized in this section.

In one embodiment, a method implemented in a data processing system (e.g., a server or the cloud) includes: receiving, by a server, first data from one or more computing devices, wherein the first data indicates stored transaction data (e.g., data related to an account of a user of a client computing device); receiving second data from the client computing device, the second data indicating a transaction request initiated by the client computing device; determining, by the server, a virtual balance for an account associated with the client computing device, wherein the virtual balance is determined based on the first data and the second data; and in response to determining the virtual balance, performing, by the server, one or more actions.

In one embodiment, the server is implemented as part of a cloud platform (e.g., Amazon Web Services). In one embodiment, the client computing device communicates with the cloud platform over a communication network. In one embodiment, the cloud platform receives the first data from a computing device that is configured to interface with and/or implement electronic transactions (e.g., on the ACH network).

In one embodiment, the virtual balance corresponds to a balance of a virtual currency (e.g., Bitcoin). In one embodiment, the server stores data regarding ownership and/or a balance of a virtual currency. In one embodiment, the state of the stored data is indicated by a blockchain.

In one embodiment, the blockchain is a list of records (blocks) that are linked and secured using cryptography. Each block contains a hash pointer as a link to a previous block, a timestamp, and transaction data. In one embodiment, the blockchain is a distributed ledger that can record transactions. In one example, the blockchain is managed by a peer-to-peer network collectively adhering to a protocol for validating new blocks.

In one embodiment, the one or more actions are performed by the server. For example, the server may send a communication to the client computing device causing an updating of a data record stored on the client computing device. For example, the client computing device may update a presentation of an image on a display of the device to indicate updated information.

In one embodiment, the virtual balance is a present virtual balance. In one embodiment, the method further comprises determining a computer model of future data transactions based on historical data, and determining a future virtual balance based on the present virtual balance and output from the computer model.

In one embodiment, the computer model comprises machine learning. In one embodiment, the computer model comprises rules-based extraction.

In one embodiment, the client computing device is a mobile client, and the transaction request is initiated by software (e.g., an application) executing on the mobile client.

In one embodiment, instead of and/or in addition to a client computing device, the server provides a network service that receives the first data and/or second data, and determines new data based on the first data and/or second data. The new data is provided to one or more other computing devices as part of the service. For example, the other computing device(s) may interact with the service via one or more application programming interface (APIs) implemented at the server.

In one embodiment, the method further comprises performing, by the server, a reconciliation. For example, after new transactions post to a real bank ledger, the system maintains a correct balance and eliminates double-counting of transactions by the real transactions which appear from a virtual ledger, as discussed further below.

In a first aspect, the present application includes a method of determining, at a first time, whether a user associated with an account can afford to spend a predetermined amount of funds before a second time that occurs after the first time. The method involves obtaining an initial balance of the account at the first time. The method also involves determining a stochastic projection model that was developed based on a set of prior transactions associated with the account. The method further involves determining, based on the stochastic projection model, a likelihood that a future balance of the account at the second time will be greater than the predetermined amount of funds. Additionally, the method involves determining that the user can afford to spend the predetermined amount of funds before the second time based on the likelihood being greater than a threshold likelihood. As described herein, “determining” a stochastic projection model may involve generating and/or training the stochastic projection model (or aspects thereof), or retrieving an already-configured stochastic projection model.

In a second aspect, the present application includes a method of predicting, at a first time, a future balance of an account at a second time. The method involves obtaining an initial balance of the account at the first time. The method also involves determining a stochastic projection model that was developed based on a set of prior transactions associated with the account. The method further involves determining, based at least in part on the stochastic projection model, a predicted cash flow amount over a predetermined period of time. Additionally, the method involves determining a ratio between the predetermined period of time and a duration between the first time and the second time. Further, the method involves determining, based on the predicted cash flow amount and the ratio, an expected cash flow amount between the first time and the second time. The method additionally involves predicting the future balance of the account based on the initial balance and the expected cash flow amount.

In a third aspect, the present application includes a method of generating a virtual balance model for predicting future account balances. The method involves obtaining a set of transaction records associated with an account, each transaction record including at least (i) a date on which the transaction occurred and (ii) an amount of funds transferred. The method also involves identifying, from a first subset of the transaction records, one or more fixed-value periodic transactions. The method further involves determining one or more rules based on the one or more fixed-value periodic transactions. Additionally, the method involves generating a stochastic projection model based on a second subset of the transaction records that are different from the first subset, wherein the stochastic projection model is operable to predict future cash flows in the account. Further, the method involves generating the virtual balance model based on a combination of the one or more rules and the stochastic projection model.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements,

FIG. 1 shows a system to determine present and future virtual balances associated with a client computing device, according to one embodiment.

FIG. 2 shows a system for implementing communications between a server and one or more user terminals, a cloud platform, a client device, and/or other computing devices, according to one embodiment.

FIG. 3 shows a block diagram of a data processing system, which can be used in various embodiments.

FIG. 4 shows a block diagram of a client computing device for a user, according to one embodiment.

FIG. 5 shows an example probability distribution for predicting a future account balance, according to various embodiments.

FIG. 6 is a schematic diagram of a portion of an example Markov Chain for predicting volatility, according to various embodiments.

FIG. 7 illustrates an example user interface, according to various embodiments.

FIG. 8 is a flowchart of an example method, according to various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment; nor are separate or alternative embodiments mutually exclusive of other embodiments. Moreover, various features are described which may be exhibited by some embodiments and not by others. Similarly, various requirements are described which may be requirements for some embodiments but not other embodiments.

It has been realized that the ACH network (and software applications that utilize bank balance data records as an external data source) presents a technical problem in which a computing device associated with the bank balance does not store or otherwise process data using an accurate balance for an account of a user. For example, the balances for various users of a system get out-of-date when a payment is originated via a third-party originator running transactions via the ACH network. The present embodiments provide a technical solution that improves the accuracy of these balances (and/or other balances stored on one or more computing devices, for example, in a database).

As an illustration of the technical problem, consider that a user has a checking account with $1,000 in it. The user opens a software application (e.g., on a client device). The software application finds that the user has $1,000 by accessing this balance via any method (e.g., electronic access via an API) which reads balances within accounts (e.g., third-party systems, screen-reading using user credentials, etc.). A user then runs, for example, a bill payment interaction with the application, in the amount of $600, which will originate the funds via a third-party originator (e.g., money transmitter) over the ACH network. As the transaction is originated by a third-party money transmitter, and the network is the ACH, which takes two business days to clear, there will be between two to five calendar days during which the banking balance, which the application relies on to set the balance, does not reflect this transaction (e.g., the current status or state of the account as affected by the transaction is not reflected in data records stored on various computing devices in the system). Thus, when relying strictly on the banking balance, the software application will interpret or represent the balance as $1,000. In such a case, the user may overdraft his or her account, if the user attempts, for example, to initiate another transaction on the same day (or before the balance updates) in an amount that will exceed $1,000 when added to the first transaction (for example, another $600 transaction).

It has been realized that such networked transaction computing systems would benefit from a way to accurately adjust and represent probable future transactions/balances on the user's account, for example in order to prevent these kinds of overdrafts. The software application utilizing the balance inspection and origination of ACH through third-party providers would benefit from having this balance, as then the software logic can be implemented at that layer to prevent transactions which would overdraw or drain the bank balance, based on the knowledge of the transactions that will likely clear at that time. The present embodiments provide a technical solution to this problem by using a software module (e.g., that can be implemented by a cloud/server and/or client device(s)) that adjusts the available funds found in a banking application in accordance with yet-to-clear transactions, particularly those originating from a third-party money transmitter, and of which the software application is aware (e.g., because the software application is the source of origination of one or more financial transactions that are cause to occur over the ACH network).

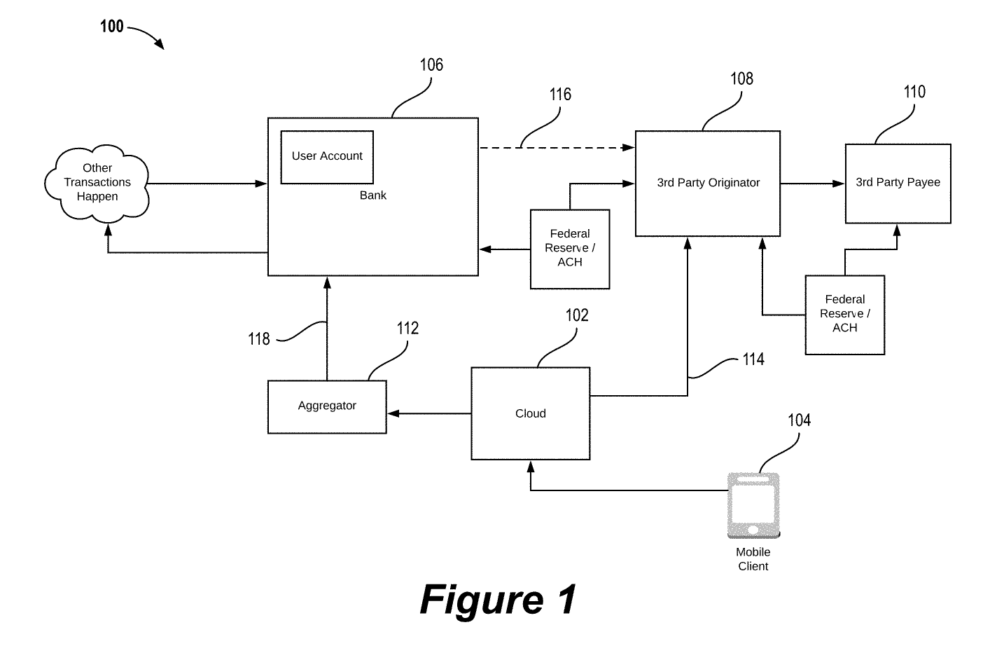

FIG. 1 shows a system 100 for determining present and future virtual balances associated with a client computing device, according to one embodiment. In one example, the present virtual balance is determined at least in part based on knowledge of transactions initiated by the above software application.

The system 100 includes computing devices 102, 106, 108, 110, and 112. In one example, computing device 102 is a server that receives first data from one or more of computing devices 106, 112, 108, and 110. The server receives second data from client computing device 104. The second data indicates a transaction request initiated by, for example, a user of client computing device 104.

In one embodiment, the transaction request is initiated in response to an input via a user interface of a software application executing on client computing device 104. In one example, the input initiates a transaction for an account associated with a user.

In one embodiment, the transaction request is received by computing device 102, which processes the request including initiating electronic communications over a network (e.g., the ACH network). In one example, the electronic communication causes a transaction to occur in a computing network that changes a data record of the user on computing device 106 and/or other computing devices (e.g., after a one or more day delay from initiation of the transaction by the client device for an ACH transaction).

In one embodiment, a system (e.g., computing device 102 of FIG. 1) maintains a “virtual balance,” which consists of the current posted balance, plus transactions that the software application on client computing device 104 originated, but which have not yet appeared in the main banking system due to the timing of payments on the ACH network (e.g., data records on computing device 106 have not been updated to reflect adjustments regarding these recently originated transactions).

The system then performs the maintenance of this “virtual balance” by maintaining data record(s) or other forms of stored data, for example as a separate addendum ledger to the actual ledger presented by the banking system itself (e.g., data regarding an account of the user as provided over a network by the computing device 106). By combining or otherwise using information from these two ledgers, an accurate, or at least improved, present “virtual balance” is then computed. The “virtual balance” is then the value used, for example by computing device 102 and/or client 104, to evaluate insufficient funds computations and perform recommendations to the user with regard to the user's finances, and it generally replaces the actual balance represented by the bank at any point in time.

In one embodiment, a reconciliation for the virtual balance above is performed. For example, after new transactions post to the real bank ledger, the system maintains a correct balance and eliminates double-counting of transactions by the real transactions which appear from the virtual ledger.

In other embodiments, using information of and data regarding a current banking balance, past actual transactions acquired via the data feed to a bank (e.g., via computing device 106), and transaction(s) originated, but not yet cleared, by the software application (e.g., on mobile client 104), a model of projected future cash flows on any given upcoming dates, and thus balances on any given upcoming dates can be projected. This method integrates not only those transactions originated via the application itself against a third-party originator (or against another computing device or service), but also the past banking history and transaction ledger of the account of the user, even prior to the installation of the application. In some embodiments, this data can be used in conjunction with one or both of two methods as described below in order to compute the cash flow (and future virtual balances) on various future dates, These methods can be used separately or together for any given system.

In a first method, rules-based extraction of fixed-value, or ranged-value, recurring transactions on a monthly, annual, weekly, or biweekly (other predetermined time periods can be used) allows the application to predict those transactions that are likely to occur on the banking ledger in the future (after being processed by the payment computing network).

In a second method, machine learning (e.g., of the Markov Monte Carlo stochastic projection variety) can be used to predict, without rules, the expected spend on different categories of transactions. This expected spend on a monthly or weekly basis, automatically adjusted for seasonality by the machine learning, can be amortized into expected daily expenditure or income on a given day of the week, and thus assist in computing expected future balances on the given date, Using this more sophisticated “expected balance” (future virtual balance) computation, the system can make recommendations to the user, for example, regarding expenditure, and flag large transactions the user attempts to originate from within the software application, if the transaction is expected to cause an overdraft, or to bring the balance below a certain value the user, for example, configures. In one embodiment, this second example solution is built upon and/or uses the mechanism of first example solution above.

Data connection 114, as shown in FIG. 1, describes a communicative link between the cloud 102 and the third-party originator 108, from which a software application (e.g., on mobile client 104) originates transactions, which may not immediately appear within the banking ledger (and thus balances) of computing device 106 that computing device 102 utilizes to determine a balance on the user account (which is then communicated to the software application on mobile client 104). Because the application originates these transactions, it can combine the internal ledger with the external banking ledger, and combine balances, for the future virtual balance.

Data connection 116, as shown in FIG. 1, describes a possible communicative link between the bank 106 and the third-party originator 108. The bank 106, and the account of the user that is used as a transaction ledger and balance data source, may send funds into the ACH clearance systems/reserve once requested by the third-party originator 108/money transmitter. This is the delayed-display debit (or alternatively credit in other use cases, for example receiving peer-to-peer transactions within the system) from the user account which benefits from the “virtual balance” logic above, as the transfer of information over data connection 116 may occur, for example, 1-5 days after origination from the software application (in FIG. 1, e.g., the mobile client 104 and subsequently cloud 102). In FIG. 1, cloud 102 refers to any computing system or server system accessible over a wide area network, such as the Internet, capable of executing applications, storing data, and otherwise providing a remotely accessible computation platform.

At data connection 118, which is shown in FIG. 1, describes a communicative link between the aggregator 112 and the bank 106, which may be the source of the non-virtual ledger and bank-provided balance (data obtained over a communication network from computing device 106). In one embodiment, the aggregator 112 can be, for example, a code module within the originating software application itself, or a third-party. In other embodiments, the aggregator 112 is implemented as software within computing device or cloud 102. The data connection 118, between the aggregator 112 and the bank 106, generally represents the access by computing device 102 and client 104 to the bank's actual, posted balances and ledger entries.

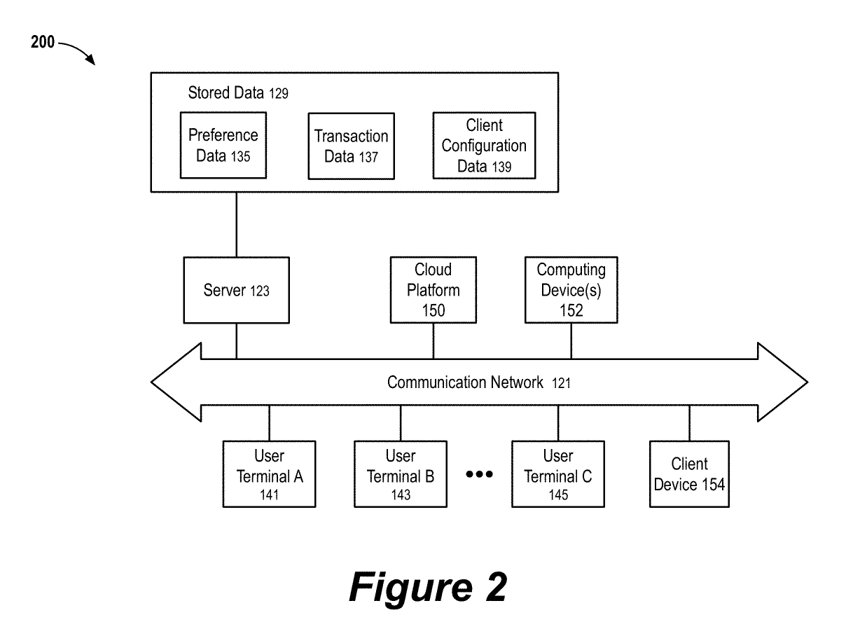

FIG. 2 shows a system 200 for implementing communications between a server and one or more user terminals, a cloud platform, and/or other computing devices, according to one embodiment. In FIG. 2, the user terminals (e.g., 141, 143, 145) are used to access a server 123 over a communication network 121. Server 123 can be used, for example, as the computing device/cloud 102 of FIG. 1. Server 123 also can communicate with cloud platform 150 and one or more other computing devices 152. Server 123 also communicates with client device 154. Client device 154 can be used, for example, as the client computing device 104 of FIG. 1.

The server 123 may include one or more web servers (or other types of data communication servers) to communicate with the user terminals (e.g., 141, 143, . . . , 145) and/or other computing devices. The server 123 is connected to a data storage facility to store data 129, such as user preference data 135, transaction data 137, and client configuration data 139.

Transaction data 137 can include, for example, data received from computing device 106 regarding the current balance of a user as reflected by data stored on the computing device 106. Transaction data 137 also can include, for example, the present and future virtual balances determined by the server 123.

Preference data 135 can include, for example, a configuration selected by a user using client device 154. This configuration can define how transactions are handled by server 123.

Client configuration data 139 can include, for example, security and other policies stored and/or defined by server 123. These policies can be required to be implemented by client device 154 in order for the software application on client device 154 to initiate transactions via server 123.

Although FIG. 2 illustrates an example system 200 implemented in client server architecture, embodiments of the disclosure can be implemented in various alternative architectures. For example, the server 123 can be implemented via a peer to peer network of user terminals or other devices, where data is shared via peer to peer communication connections.

For example, the determination of present and virtual balances may be implemented in the user terminals or other devices, instead of running on one or more centralized servers.

In some embodiments, a combination of client server architecture and peer to peer architecture can be used, in which one or more centralized servers may be used to provide some of the information and/or services and the peer to peer network is used to provide other information and/or services. Thus, embodiments of the disclosure are not limited to a particular architecture.

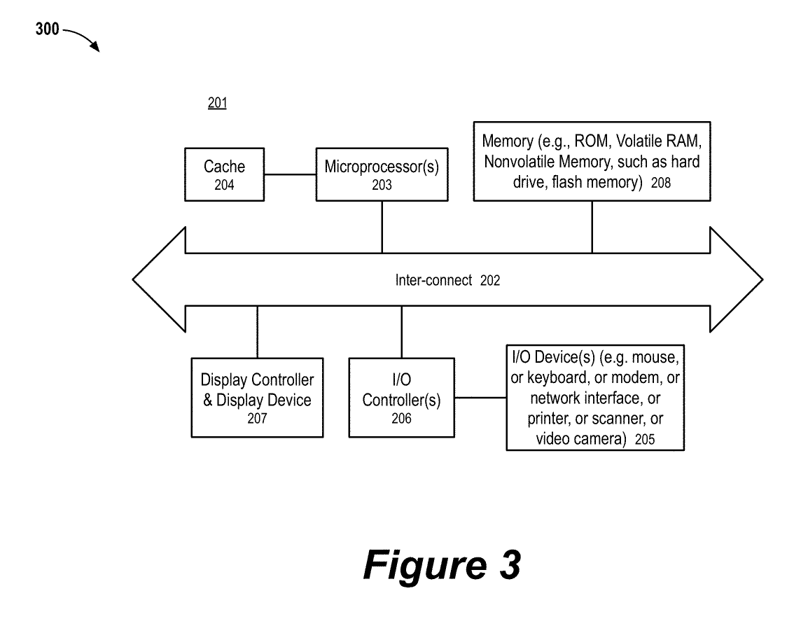

FIG. 3 shows a block diagram 300 of a data processing system, which can be used in various embodiments. While FIG. 3 illustrates various components of a computer system, it is not intended to represent any particular architecture or manner of interconnecting the components. Other systems that have fewer or more components may also be used.

The system 201 includes an inter-connect 202 (e.g., bus and system core logic), which interconnects a microprocessor(s) 203 and memory 208. The microprocessor 203 is coupled to cache memory 204 in the example of FIG. 3.

The inter-connect 202 interconnects the microprocessor(s) 203 and the memory 208 together and also interconnects them to a display controller and display device 207 and to peripheral devices such as input/output (I/O) devices 205 through an input/output controller(s) 206. Typical I/O devices include mice, keyboards, modems, network interfaces, printers, scanners, video cameras and other devices which are well known in the art.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

The memory 208 may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 3 is used to implement server 123 and/or computing device 102, and/or other servers.

In one embodiment, a data processing system as illustrated in FIG. 3 is used to implement a client computing device. A client computing device or user terminal may be in the form of a personal digital assistant (PDA), a mobile device, a cellular phone, a notebook computer, or a personal desktop computer.

In some embodiments, one or more servers of the system can be replaced with the service of a peer to peer network of a plurality of data processing systems, or a network of distributed computing systems. The peer to peer network, or a distributed computing system, can be collectively viewed as a server data processing system.

Embodiments of the disclosure can be implemented via the microprocessor(s) 203 and/or the memory 208. For example, the functionalities described can be partially implemented via hardware logic in the microprocessor(s) 203 and partially using the instructions stored in the memory 208. Some embodiments are implemented using the microprocessor(s) 203 without additional instructions stored in the memory 208. Some embodiments are implemented using the instructions stored in the memory 208 for execution by one or more general purpose microprocessor(s) 203. Thus, the disclosure is not limited to a specific configuration of hardware and/or software.

Additional exemplary networked and distributed environments, and an exemplary computing device, are described in United States Patent Application Publication US 2009/0092124, published Apr. 9, 2009 (titled “NETWORK ROUTING OF ENDPOINTS TO CONTENT BASED ON CONTENT SWARMS”; inventors Singhal et al.; assignee Microsoft Corporation; application Ser. No. 11/866,811, filed Oct. 3, 2007), which is hereby incorporated by reference in its entirety.

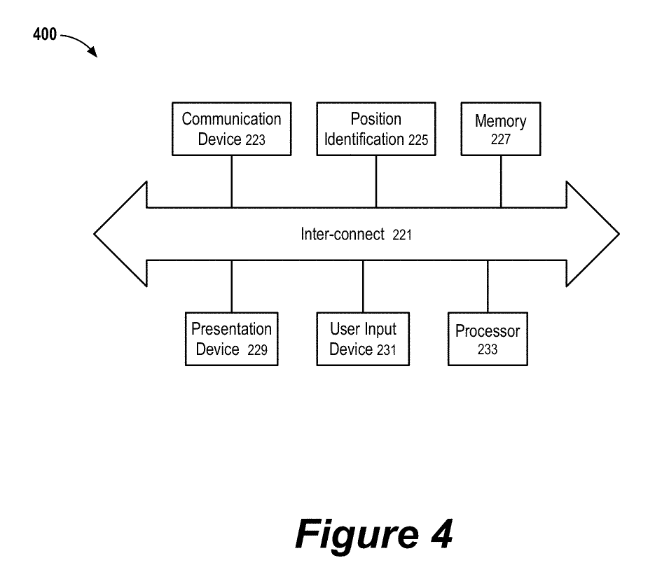

FIG. 4 shows a block diagram 400 of a client computing device, according to one embodiment. In FIG. 4, the client device includes an inter-connect 221 connecting the presentation device 229, user input device 231, a processor 233, a memory 227, a position identification unit 225 and a communication device 223.

In FIG. 4, the position identification unit 225 is used to identify a geographic location for user data created for sending to server 123. The position identification unit 225 may include a satellite positioning system receiver, such as a Global Positioning System (GPS) receiver, to automatically identify the current position of the user device.

In FIG. 4, the communication device 223 is configured to communicate with the server 123. Transaction and/or other data can be computed and presented at least in part via the processor 233 and the presentation device 229.

In one embodiment, the user input device 231 is configured to generate user data. The user input device 231 may include a text input device, a still image camera, a video camera, and/or a sound recorder, etc.

In one embodiment, the user input device 231 and the position identification unit 225 are configured to automatically tag the user data created by the user input device 231 with information identified by the position identification unit 225.

The development of stochastic projection models, as described herein, is generally based on the principles of Brownian motion. Brownian motion is itself described by the Wiener Process, which is a continuous time stochastic process. One way to describe the Wiener Process is as the scaling limit of a random walk, or other discrete-time stochastic processes with stationary independent increments.

Aspects of the present application are based on the realization that spending activities for a financial account (e.g., a checking account with a bank, a credit card, etc.) can be characterized as a Wiener Process. Transactions occur at discrete times, and can in some cases be considered stationary processes (in that the randomness does not substantially shift in level over a given period of time). Likewise, each increment in transaction data (e.g., successive transactions) can be considered random with respect to the previous transaction. Accordingly, the present disclosure contemplates that a series of financial transactions in an account can be understood as a process with stationary independent increments—and thereby can be modeled as a stochastic process.

Brownian motion can generally be defined as set forth in equation 1:

F(t)=drift+stddev*e^{r}=>Bₜ (Eq. 1)

The Stochastic Differential Equation (SDE) is defined as in equation 2, where Bₜ denotes the Wiener Process of standard Brownian motion:

dSₜ=μSₜdt+σSₜdBₜ (Eq. 2)

The analytic solution to equation 2 is set forth in equation 3, where (t) is the function for the stochastic random variable being modeled over time, and S₀ is the initial value of that random variable. In equations 2 and 3, μ is referred to as the drift coefficient, and a is referred to as the diffusion coefficient. Note that the stochastic process defined by Sₜ satisfies the Markov property.

$$S ( t ) = {S}_{0} {e}^{( μ - \frac{{σ}^{2}}{2} ) t + σ {B}_{t}} \qquad ( Eq . 3 )$$

The analytic solution to equation 2 is set forth in equation 3, where S(t) is the function for the stochastic random variable being modeled over time, and S₀ is the initial value of that random variable. In equations 2 and 3, is referred to as the drift coefficient, and a is referred to as the diffusion coefficient. Note that the stochastic process defined by Sₜ satisfies the Markov property.

In the context of modeling financial transaction spending, it is desirable to use weighted values for the mean and standard deviation. The weight of each subsequent data point diminishes, since certain patterns in the data points closer in time to the present may be more relevant in predicting future spending, compared to data points substantially in the past. Equation 4 represents the weighted series, where wᵢ is a geometric series with a limit of zero when i approaches infinity.

wᵢ=(1−a) (Eq. 4)

Using a weighted series, rather than an unweighted series, provides an additional parameter with which to determine sensitivity to changes in the variance and mean of the data samples. With this mathematical foundation, financial transaction data is modeled as Geometric Brownian Motion (with a weighted alpha series), which is used to construct a bell curve of some predicted end values based on historical measurements over time. For instance, the model may predict a future balance in an account, prior to the occurrence of the future transactions, which is based on past spending habits in a particular account.

The iterative solution to equation 3 is provided in equation 5, where N is the normal gaussian.

$${S}_{i} = {S}_{i - 1} {e}^{( μ - \frac{{σ}^{2}}{2} ) dt + σ \sqrt{dt} N ( 0 , 1 )} \qquad ( Eq . 5 )$$

In generating a model, historical numerical values (e.g., particular transaction amounts, associated with specific purchases or expenditures) serve as inputs. The model may be configured to receive one or more parameters, such as a particular future date and/or time, the weighting value a, and/or other possible parameters.

One approach to generating the model may involve instantiating an initial iterative solution, such as a model based on equation 5. The iterative solution may be interpreted to represent a “tick”—a change in an account balance over some time step (e.g., an hour, a day, the time between individual transactions, etc.). A validation process may involve guessing each change in the account balance based on some past known value, and stepping through each “tick” in the iterative solution until some end time. The accuracy of a model may generally be verified, tuned, and/or improved by determining the extent to which the model predicts past known spending.

During this “training” stage, the model may produce a probabilistic output, by running the model over multiple iterations, and assessing how many times a predicted value was determined. A probability distribution (e.g., a cumulative distribution function) may then be determined with respect to the predicted future account balance. This probability distribution may fit some type of statistical curve (e.g., normal, log-normal, etc.). The mean value of this probability distribution would represent the most likely future account balance, with the likelihood that the balance is above or below that mean value being determinable according to the shape of the probability curve.

While the mean may represent the expected value of an account's balance at some future point in time, some applications of the technique described herein may utilize other aspects of the model. For example, to answer the question of “how likely is the account to have more than $300 at the end of the month?”, the above-described probability distribution may be used to determine the percentage of predictions that lie above $300 at that future date. The probability distribution may then serve as a basis to answer the question by outputting a percentage likelihood that the account balance will exceed $300 at that future date.

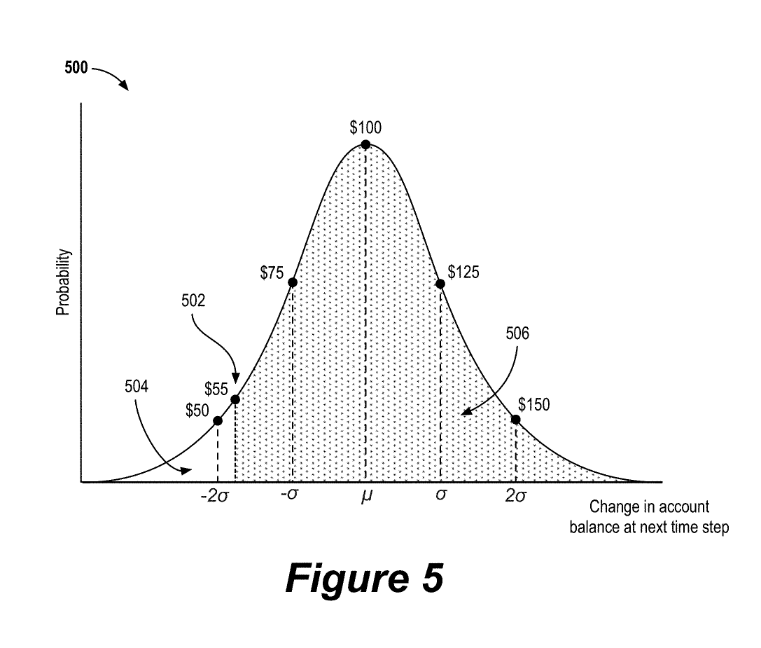

FIG. 5 depicts an example probability distribution 500 to illustrate an example technique for determining the change in an account balance between time steps (e.g., between successive days). The distribution 500 represents a normal distribution (although it may not necessarily be drawn to scale). In this example, the distribution represents the negative change in an account balance.

The mean value μ of the distribution 500 is $100. Each standard deviation a has a $25 interval. One way to interpret the distribution 500, therefore, is that there is about a 68% chance that the user will spend between $75 and $125 between the current and subsequent time “ticks.” Another way to interpret the distribution 500 is that there is about a 95% chance that the user will spend between $50 and $150 between the current and subsequent time “ticks.”

A specific example might involve answering the question of “what is the likelihood that the user will spend $55 or less?” The area under the distribution 500 is bisected along the line defined by $55 extending from point 502; separating area 504 to the left of point 502 and area 506 to the right of point 502. The proportion of the area under the distribution 500 defined by area 506, in this example, is 90%, whereas area 504 represents the remaining 10% of the area under the distribution 500. Thus, the model would predict that there is a 10% chance that the user spends $55 or less over the time interval. As can be observed in the example shown and described with respect to FIG. 5, the prediction of a future account balance may be accompanied by a confidence interval, due to the probabilistic nature of the prediction.

In some embodiments, an application that utilizes the above-described model may involve setting some threshold confidence or likelihood value as an indication of whether a user associated with the account can afford to make a particular expenditure (e.g., a vacation, a gift, etc.). For instance, whether or not a user can afford to make a particular purchase within a given time frame may be based on the premise that there is a 90% or greater likelihood that a user will have the requisite funds to make the purchase. The model may be run to determine the probability distribution, which in turn is evaluated to determine whether or not that threshold is met.

In some embodiments, an application that utilizes the above-described model may implement a “low-balance detector.” Providing a low-balance detector may involve estimating a future account balance on a regular basis (e.g., after each spending event, daily, weekly, etc.). If that future account balance is predicted with sufficient probability to be a low positive value, zero, or negative value (or to exceed a credit limit), the application may notify the user that a probable future low balance has been detected. Such a notification (e.g., a push notification, text message, automated phone call, or some other form of notification) may also provide additional information, such as recommendations as to the user's future expenditures over a period of time.

In various implementations, the accuracy of the model may be evaluated in terms of one or more error rates, such as the rate of false positives, false negatives, true positives, and/or true negatives. A model may be intentionally developed to be overly cautious (allowing for a high rate of false positives, e.g., overestimating the likely future spending), in order to mitigate the potential consequences of overspending. Such accuracy “tolerances” may be designated as one or more hyperparameters of the model. The model may be configured to use additional hyperparameters as well, such as the preference weights for false positives compared to false negatives, the alpha weighting value for Geometric Brownian Motion, the number of lookback days in the volatility Markov Chain (described in greater detail below), and/or the piecewise mapping function used to reduce the volatility probability space (e.g., linear piecewise functions, bucketed range median calculations with five quantiles, etc.). Collectively, the above-described approach to developing a “virtual balance” model may be referred to as a Geometric Brownian Motion Monte Carlo (GBMMC) simulation.

While the basic GBMMC approach based only on previous transaction values (without taking into account the payee and/or category of expenditure) may predict the future balance of a particular account with sufficient accuracy, a few aspects of technique may be beneficially improved upon. The drift value, indicating upward or downward trends in overall spending, is a substantial factor in the predictive model. However, using the basic GBMMC approach may be inaccurate in situations where the drift in overall spending changes course multiple times over a period of time. In addition, performing a “random walk” through the data may be too purely random, which may not accurately reflect the volatility in a user's spending habits over time. Moreover, the model does not take into account human factors, such as a user's ability to change their own spending habits, among other possible human influences over the trends in spending.

The stochastic projection model based on Brownian Motion has substantial utility in predicting likely future expenditure values for the types of expenses that are volatile. However, some expenses occur on a regular basis, or can otherwise be determined to a higher degree of certainty than through Monte Carlo simulations. Accordingly, the present disclosure includes the realization that a model may be constructed more accurately by observing specific cash flows as being deterministic. For example, rent, car payments, utilities, salary payments, and/or other events may be observed as periodic expenses in sample data. In various embodiments, a predicted future balance model may integrate a deterministic component therein, together with the above-described probabilistic component.

The sample data from which a model is developed may include information embedded therein, such as merchant identification information (e.g., the payee), a classification or category of the expense, the date on which the transaction occurred, and/or other possible information. Certain patterns may be observed from such sample data, such as payments to a particular individual for the same amount of money on the first day of each month (e.g., rent). As another example, a pattern may be observed in which a user receives income every other Friday (e.g., biweekly salary payments). Various such patterns may be extracted from a dataset to determine a set of “rules” or known events that are expected to occur on a periodic basis.

In general, a technique for identifying periodic expected transactions involves determining a set of samples from a dataset that occur periodically, and for a consistent amount of money. In some instances, if the variance in one or both of those values (in the periodicity of a set of transactions, or the amount of money exchanged) is sufficiently low (e.g., phone bills with slight overage charges, gas or electric bills that vary by a small amount, rent payments that are made between the first day of the month and the fifth day of the month, etc.), that subset of transactions may be considered a deterministic recurring expenditure.

The subset of data samples from a set of past transactions that reflect recurring expenditures may then be removed from the data samples, and not used to generate the probabilistic aspect of the predicted future balance model. The “rules” from that subset of expenses are extracted, and combined with the Monte Carlo simulation to determine more complicated queries (by shifting the predicted balance value by some deterministic amount, e.g., shifting the mean of the probability curve described above).

The probabilistic-only model based on GBMMC may be insufficiently accurate in some cases, as the weighted standard deviation is considered to be constant over a period of time. However, spending volatility is a common phenomenon in financial transaction data. The degree of recent volatility may be used to estimate the future volatility, to a greater extent than the degree of long past volatility.

One way to address the meta-modeling problem of predicting volatility in future spending is to treat the volatility as deterministic. However, the present application contemplates the realization that future volatility in financial transaction data has not been observed to be determinable to a high degree of certainty. Thus, modeling human behavior (e.g., a user's spending habits) involves developing a probabilistic model of spending per unit time or “tick,” but also developing a probabilistic model to predict the volatility over time.

One way to develop a probabilistic volatility model involves using Markov Chain Monte Carlo (MCMC) techniques to sample the probability distribution of the stochastic spending model. The MCMC techniques described herein can create samples from multi-dimensional random variables, from which constituent dimensions of that random variable (such as variance and mean) can be estimated. In a Markov Chain, the volatility at a given point in time is considered memoryless. If volatility has a value of x₁ at time t₁, a guess can be made by inputting x₁ into a transition probability matrix to guess the subsequent volatility value x₂. In other words, the historic timeseries of volatility values are used to generate a transition probability matrix, but otherwise do exhibit a hysteresis on the volatility value over time.

Alternatively, each volatility “state” can be modeled as a vector based on two or more prior volatility values. In this example, a volatility value of x₄ at time t₄ may be determined based on prior values x₁, x₂, and x₃ a 3-day lookback vector). However, one drawback to this approach is that, for small datasets, the likelihood of having two transitions lead to the same state is low. As a result, a Markov Chain constructed from the transition states would likely not reflect the randomness of the volatility, but instead follow a predictable path through the Markov Chain.

To reduce the chance of developing predictable Markov Chain pathways, the present application contemplates stochastically modeling the normalized differential of the volatility using an additive chain, rather than attempting to predict the volatility directly. Modeling the volatility in this manner may be referred to herein as “drift disposition”. The resulting model may be characterized by two additional hyperparameters: n, which is the number of past days to consider in performing the random walk MCMC; and

$$σ ( \frac{dv}{dt} ) ,$$

where a represents the geometric differential normalizer function, and

$$\frac{dv}{dt}$$

indicates the instantaneous volatility of spending at a discrete location in time.

The random walk MCMC process for modeling volatility can be described using set theory and mathematical notation, as in equations 6, 7, and 8. In the following expressions, T represents the set of all discrete times, V represents the set of all volatilities present in the historical data, and A represents the set of all normalized multipliers allowed in the Markov Chain model (i.e., the range of

$$σ ( \frac{dv}{dt} ) ) .$$

$$A = \{ σ ( \frac{dv}{dt} ) \text{:} v ∈ V ⋐ \qquad ( Eq . 6 )$$

Consider the following example for spending, described by equation 7, where n is equal to three days.

$$σ ( \frac{dv}{dt} ) = \{ \begin{matrix}\frac{dv}{dt} ∈ ( - ∞ , - 0.03 ) \text{:} - 3 \% \\ \frac{dv}{dt} ∈ [ - 0.03 , 0.03 ] \text{:} 0 \% \\ \frac{dv}{dt} ∈ ( 0.003 , ∞ ) \text{:} 3 \%\end{matrix} \qquad ( Eq . 7 )$$

Equations 6 and 7 can be consolidated as shown in equation 8 below.

$$A = \{ - 0.03 , 0 , 0.03 \} = \{ - 3 \% , 0 \% , 3 \% \} = σ ( \frac{dv}{dt} ) \text{:} v ∈ V ⋐ \qquad ( Eq . 8 )$$

Based on the result of the above example, the change volatility at a given discrete time may be bound to one of three values: −3%, 0%, and 3%. In this example, a 3-day lookback vector has 27 different possible permutations. If a given subset of data samples indicates a change in volatility that is less than −3%, then the model may be trained with a volatility data value of −3% (i.e., the volatility is normalized and assigned to discrete values in accordance with a piecewise linear function). Likewise, if the data samples indicate a change in volatility that is between −3% and 3%, then the model may be trained with a volatility data value of 0%. In addition, if the data samples indicate a change in volatility that is greater than 3%, then the model may be trained with a volatility data value of 3%, By mapping the observed volatility fluctuations in this manner, the variable space is significantly reduced, meaning that the probability matrix for each transition state can be generated based on at least several samples.

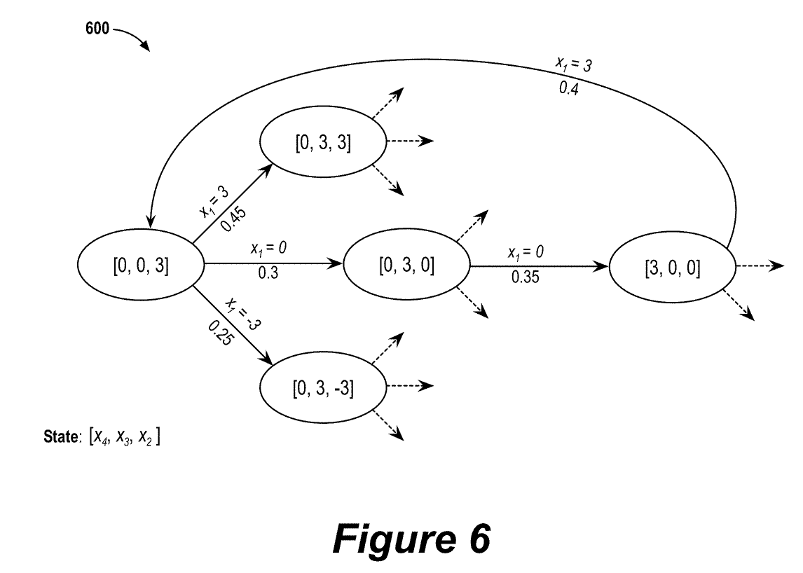

FIG. 6 illustrates an example portion of a Markov Chain 600 based on the above-described example. In FIG. 6, each state (represented as ellipses) represents the volatility values (that is, the 3-day lookback vector) for the past three time steps: values x₄, x₃, and x₂ (as a vector in that order). The Markov Chain forms a directed graph between states in the lookback vector space. In stepping through the Markov Chain 600, it is possible to transition from a given state to a future state along one of three paths: x₁=3, x₁=0, and x₁=−3 (representing 3%, 0% and −3%). Adding up the probabilities for each of the three paths equals 100%, since a transition to one of three future states must occur with each successive time interval.

In the example shown in FIG. 6, the initial state is defined by the 3-day lookback vector [0, 0, 3], where the left-most value is the volatility furthest in the past (x₄) and the right-most value is the most recent volatility value (x₂). In this particular value, from the state [0, 0, 3], the likelihood that the next volatility value (x₁) will be 3% is 45%, which would step through the Markov Chain 600 to the state [0, 3, 3]. Likewise, the likelihood that the next volatility value (x₁) will be 0% is 30%, which would step through the Markov Chain 600 to the state [0, 3, 0]. Similarly, the likelihood that the next volatility value (x₁) will be −3% is 25%, which would step through the Markov Chain 600 to the state [0, 3, −3], In this example, simulating a random walk through the Markov Chain over many iterations would reveal that increased volatility (3%) typically follows from a previous state of increased volatility (3%)—at least more often than a state of no change in volatility or a decrease in volatility.

FIG. 6 also illustrates how stepping through the Markov Chain 600 can result in a loop. If there is no change in volatility for two successive states (moving from state [0, 0, 3] to [0, 3, 0] and then to [3, 0, 0]) then there is a possibility that the next state returns back to the initial state [0, 0, 3]—specifically, when there is a normalized 3% increase in volatility. In training the probability weights of the Markov Chain 600 based on historical data, each state should have multiple data points that inform those probability weights, depending on the size of the training dataset. Once trained, the Markov Chain 600 can be used to predict changes in volatility over time through random walk Monte Carlo simulations.

Although the above-described example maps substantially continuous volatility values onto three possible values (−3%, 0%, and 3%), it should be understood that other mappings—linear or non-linear—may be used. The simple piecewise function described above is merely provided as an example for explanatory purposes.

GBMMC-based probability distributions may be generated for different categories of transactions. A predetermined set of categories (e.g., food, entertainment, transportation, clothing, etc.) may be designated, and separate probability distributions may be modeled for each of those categories. In addition, each category may have associated therewith its own volatility Markov Chain for estimating future changes in volatility with respect to that particular category. The present application contemplates that the transaction training data may be divided along a variety of dimensions to create more granular models having more constituent components.

To summarize, the present disclosure describes techniques for generating and using models that predict the likely balance of a financial account at a future time. Transaction data may include a date, time, amount of money transferred, payee, category of expenditure, and/or other related information. Some additional properties, such as the day of the week, may be derived from the data samples and used as additional parameters to train with,

Initially, the development process involves identifying recurring or substantially periodic expenditures from a historical transaction dataset associated with the account (e.g., rent, utility payments, salary direct deposits, eta). The recurring data expenditures may be modeled as substantially deterministic transactions, which are highly likely to occur on a regular basis and therefore are excluded from the training of the probabilistic aspect of the model. The permitted tolerance in what may be considered a “recurring” transaction may vary (e.g., same day of the month for the exact same amount of money, occurring within a 3-day window of the month for approximately the same amount of money, etc.), depending upon the particular implementation. A set of deterministic “rules” are extracted from these periodic expenditure data samples.

With the remaining set of non-recurring transaction data samples, a probabilistic aspect of the model may then be generated. For a given time step, one or more probability distributions are generated from the transaction data, representing the predicted change in the account balance over a given period in time. In a preferred embodiment, a plurality of probability distributions are generated, each corresponding to a respective state in a Markov Chain, where each state represents a set of volatility values corresponding to a respective set of previous time increments—thereby accounting for “drift disposition,” or trends in volatility fluctuations over time. In theory, a longer lookback period would provide for a more accurate representation of the volatility shift over time, but in most cases a lookback period of around three time increments provides a sufficient number of states in the Markov Chain to provide sufficient accuracy while reducing the risk of the Markov Chain becoming too predictable or deterministic.

Finally, a probabilistic model may be trained using the non-recurring transaction data using GBMMC, as described above. A componentized version of a probability distribution may be used, which can be modified by or otherwise combined with the probability matrices of the volatility Markov Chain.

The development of a model that combines the rules-based deterministic aspect, together with the Markov Chain-based probabilistic aspect, may be accomplished using the following process. First, identify a set or sets of samples within a financial transaction dataset associated with a user's account that represent recurring or periodic transactions. Remove that set or sets of samples from the dataset, and extract one or more “rules” therefrom representing future spending events that are highly likely to occur. With the remaining, non-recurring portion of the financial transaction dataset, derive the “drift disposition” (the volatility Markov Chain) of the transaction data which, when trained, forms the probabilistic aspect of the model. Then, using the same non-recurring portion of the financial transaction dataset, use GBMMC to generate a probability distribution that models the randomness of the non-recurring portion of dataset.

Some combination of the rules-based deterministic model, the volatility Markov Chain probabilities, and the GBMMC probability distribution may be used to formulate a “virtual balance” model. The virtual balance model may be configured, based on the preferences of a user or organization, to output information based on the predicted future balance of a user's financial account. As a specific example, a user may wish to know how much money will remain in the user's bank account at the end of the month, erring substantially on the side of caution (e.g., 95% confidence). In this example, each transition probability between successive time states or “ticks” may be sampled on the low end of the distribution curve (e.g., at the 5% mark, where there is only a 5% chance that the value in the account is below that amount), and the model may be stepped through until the ending time tick and added to the rules-based recurring or substantially periodic expenditures to observe the cautious estimate as to the balance of the user's bank account at that ending time.

Many other use cases are also possible, which may not be explicitly contemplated herein. For example, a “low balance detector” may be configured to warn a user that insufficient funds are likely (or otherwise possible within some threshold tolerance) in the near future. The number of days the low balance detector looks ahead to, the degree of confidence necessary to trigger the warning, and a variety of other aspects of such a low balance detector may be configured according to the particular needs of a user or organization. As another example, a system implementing the model may transmit a notification or email to a user when there is an 80% or greater likelihood that the user will be unable to pay a particular recurring bill the following month. As yet another example, a credit card company may wish to transmit marketing materials or extend exclusive offers to users associated with accounts that have a 95% or greater likelihood of paying all expenses for the following year. The scope of the present disclosure encompasses the broad range of possible outputs and/or actions taken based on outputs of the model.

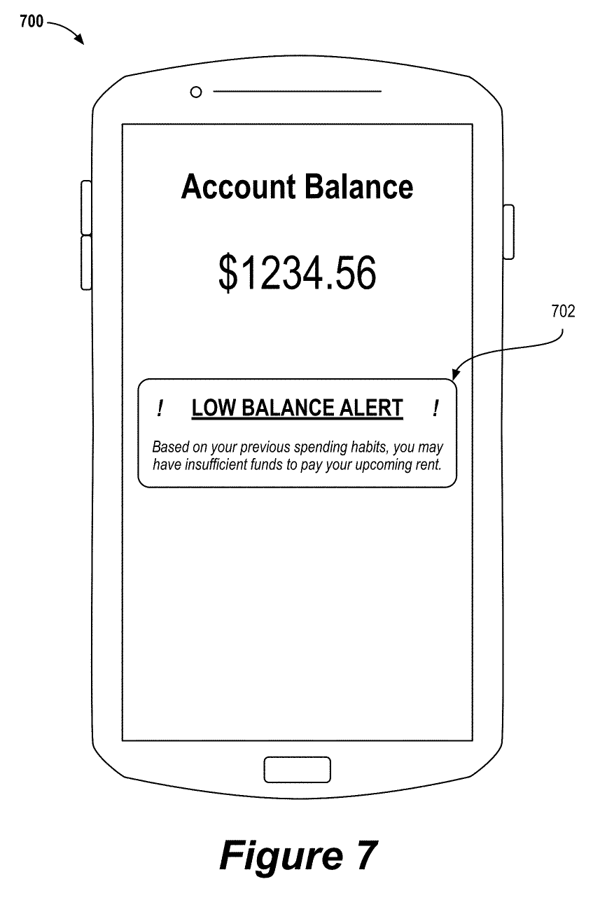

The models described herein may be integrated with, or accessible by, a website or application, either for an organization or for end users. FIG. 7 depicts an example user interface 700 on a smartphone. A service provider may publish an application, which builds upon the future balance model to monitor a user's spending and notify the user about potential issues (e.g., low balance, spending near or above a credit limit, etc.) before the occurrence of such issues. In the example of FIG. 7, the application generated a “low balance alert” 702, which notifies the user that their recent spending habits may render them unable to make an upcoming rent payment.

For example, the deterministic aspect of the model may determine a recurrent rent payment of $1,000 that is made on the first of the month. If the first day of the month is one week away, the probabilistic aspect of the model may be used to predict the likely future balance of that account to some level of confidence. In this example, the starting balance is $1,234,56. If the model predicts that there is a substantial likelihood that the user will spend over $234.56 (and receive no income) over the upcoming week, then there is also a substantial likelihood that the user will be unable to pay for rent—which, in turn, causes the application to generate the alert 702.

Although not explicitly shown and described herein, a variety of user interfaces may be used to convey inferences drawn from the models described herein. The scope of the present application encompasses all such user interfaces.

In addition, the present disclosure contemplates the use of machine learning algorithms, models, and techniques other than Markov Chains. For example, one or more aspects of the model may be implemented using one or more neural networks, such as recurrent neural networks (RNNs), long short term memory (LSTM) based networks, and/or Bayesian networks, among other possible models.

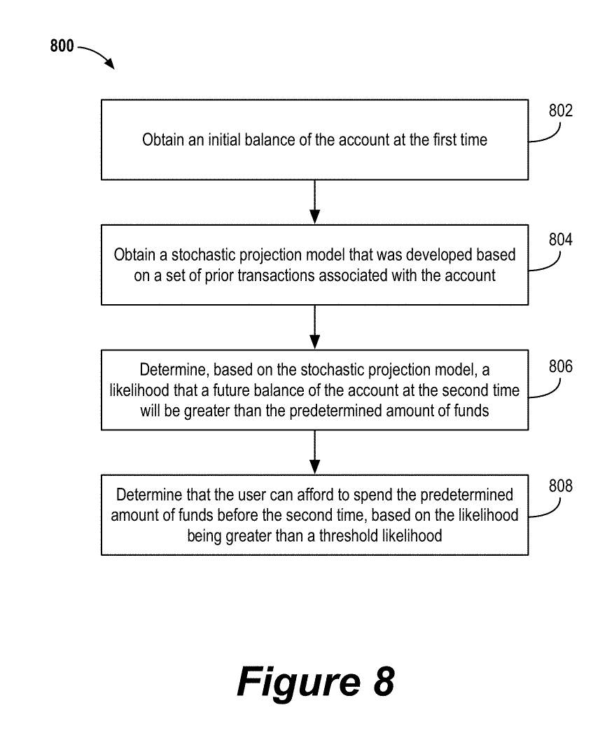

FIG. 8 illustrates an example method 800 of determining, at a first time, whether a user associated with an account can afford to spend a predetermined amount of funds before a second time that occurs after the first time. The method may be performed on or by a computing device, computing system, server, or some other processing apparatus. The method may also involve obtaining stored information and transmitting messages to other devices. The predetermined amount of funds may be input by a user manually (e.g., asking the application “can I afford to purchase X item?”) or may be a reference to some future monetary need (e.g., the payment of monthly bills or rent).

At block 802, the method involves obtaining an initial balance of the account at the first time. The initial balance may be pulled from a bank or credit card company API, or obtained through other data channels. In some cases, multiple accounts may be combined into a single virtual account.

At block 804, the method involves obtaining a stochastic projection model that was developed based on a set of prior transactions associated with the account. The stochastic projection model may be developed based on the GBMMC and MCMC methods described above.

At block 806, the method involves determining, based on the stochastic projection model, a likelihood that a future balance of the account at the second time will be greater than the predetermined amount of funds. Determining this likelihood may involve performing one or more calculations similar to those shown and described above with respect to FIG. 5.

At block 808, the method involves determining that the user can afford to spend the predetermined amount of funds before the second time based on the likelihood being greater than a threshold likelihood. The threshold likelihood may be designated by the user, or by an organization.

In this description, various functions and operations may be described as being performed by or caused by software code to simplify description. However, those skilled in the art will recognize what is meant by such expressions is that the functions result from execution of the code by a processor, such as a microprocessor, Alternatively, or in combination, the functions and operations can be implemented using special purpose circuitry, with or without software instructions, such as using an Application-Specific Integrated Circuit (ASIC) or a Field-Programmable Gate Array (FPGA), Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine-readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

No claim element herein is to be construed under the provisions of 35 U.S.C. 112, sixth paragraph, unless the element is expressly recited using the phrase “means for.”

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method of determining, at a first time, whether a user associated with an account can afford to spend a predetermined amount of funds before a second time that occurs after the first time, the method comprising:
obtaining an initial balance of the account at the first time;
determining a stochastic projection model that was developed based on a set of prior transactions associated with the account;
determining, based on the stochastic projection model, a likelihood that a future balance of the account at the second time will be greater than the predetermined amount of funds; and
determining that the user can afford to spend the predetermined amount of funds before the second time based on the likelihood being greater than a threshold likelihood.

2. The method of claim 1, wherein the stochastic projection model includes a probability distribution generated using a Markov chain Monte Carlo (MCMC) process.

3. The method of claim 1, wherein determining the likelihood comprises:
generating, based on the stochastic projection model, a probability distribution representing predicted expenditures for the account between the first time and the second time; and
determining the likelihood, based on the probability distribution, as a probability that the predicted expenditures is greater than the difference between the initial balance and the predetermined amount of funds.

4. The method of claim 1, wherein the stochastic projection model comprises a plurality of probability distributions generated from the set of prior transactions representing predicted expenditures for the account between the first time and the second time, each probability distribution being associated with a respective category of transactions, each probability distribution of the plurality being generated based on a subset of the set of prior transactions associated with its respective category, and wherein determining the likelihood comprises:
determining the likelihood, based on the plurality of probability distributions, as a probability that a total amount of the predicted expenditures for the plurality of categories.

5. The method of claim 4, wherein determining the likelihood further comprises:
determining, for each category, an upper expenditure amount representing an upper boundary of a confidence interval for the respective probability distribution, wherein an aggregation of the confidence intervals is equal to the threshold likelihood; and
determining that the likelihood exceeds the threshold likelihood based on a sum of the upper expenditure amounts being less than the difference between the initial balance and the predetermined amount of funds.

6. The method of claim 4, wherein determining the likelihood further comprises:
generating, based on the plurality of probability distributions, a combined probability distribution representative of predicted expenditures for the account between the first time and the second time; and
determining the likelihood, based on the combined probability distribution, as a probability that the predicted expenditures is greater than the difference between the initial balance and the predetermined amount of funds.

7. The method of claim 1, wherein the stochastic projection model includes a recurrent neural network (RNN).

8. The method of claim 7, wherein the recurrent neural network comprises a plurality of long short-term memory (LSTM) units.

9. The method of claim 1, further comprising:
based on the determination that the user can afford to spend the predetermined amount of funds before the second time, transmitting, to a computing device associated with the user, a message indicating that the user can afford to spend the predetermined amount of funds.

10. The method of claim 1, further comprising:
obtaining one or more rules indicative of fixed-value transactions associated with the account that occur on a periodic basis,
wherein determining the likelihood that the future balance of the account will be greater than the predetermined amount of funds comprises:
determining the future balance of the account at the second time as a combination of the initial balance, an expected cash flow based on the one or more rules, and predicted expenditures based on the stochastic projection model; and
determining the likelihood as a probability that the predicted expenditures will exceed a combination of the initial balance, the expected cash flow, and the predetermined amount of funds.

11. A method of predicting, at a first time, a future balance of an account at a second time, the method comprising:
obtaining an initial balance of the account at the first time;
determining a stochastic projection model that was developed based on a set of prior transactions associated with the account;
determining, based at least in part on the stochastic projection model, a predicted cash flow amount over a predetermined period of time;
determining a ratio between the predetermined period of time and a duration between the first time and the second time;
determining, based on the predicted cash flow amount and the ratio, an expected cash flow amount between the first time and the second time; and
predicting the future balance of the account based on the initial balance and the expected cash flow amount.

12. The method of claim 11, wherein determining the likelihood further comprises:
obtaining one or more rules indicative of fixed-value transactions associated with the account that occur on a periodic basis,
wherein the expected cash flow is further determined based on the one or more rules.

13. The method of claim 11, wherein the stochastic projection model comprises a plurality of probability distributions generated from the set of prior transactions representing predicted expenditures for the account between the first time and the second time, each probability distribution being associated with a respective category of transactions, each probability distribution of the plurality being generated based on a subset of the set of prior transactions associated with its respective category, and wherein determining the predicted cash flow amount comprises:
generating, based on the plurality of probability distributions, a combined probability distribution representative of predicted expenditures for the account over the predetermined period of time; and
determining the predicted cash flow amount based on the combined probability distribution.

14. The method of claim 11, wherein the stochastic projection model comprises a plurality of probability distributions generated from the set of prior transactions representing predicted expenditures for the account between the first time and the second time, each probability distribution being associated with a respective category of transactions, each probability distribution of the plurality being generated based on a subset of the set of prior transactions associated with its respective category, and wherein determining the predicted cash flow amount comprises:
determining, for each category, an upper expenditure amount representing an upper boundary of a confidence interval for the respective probability distribution; and
determining the predicted cash flow amount as a sum of the upper expenditure amounts.

15. A method of generating a virtual balance model for predicting future account balances, the method comprising:
obtaining a set of transaction records associated with an account, each transaction record including at least (i) a date on which the transaction occurred and (ii) an amount of funds transferred;
identifying, from a first subset of the transaction records, one or more fixed-value periodic transactions;
determining one or more rules based on the one or more fixed-value periodic transactions;
generating a stochastic projection model based on a second subset of the transaction records that are different from the first subset, wherein the stochastic projection model is operable to predict future cash flows in the account; and
generating the virtual balance model based on a combination of the one or more rules and the stochastic projection model.

16. The method of claim 15, wherein generating the stochastic projection model comprises:
generating, using a Markov chain Monte Carlo (MCMC) process, at least one probability distribution of a predicted cash flow amount over a period of time,
wherein the stochastic projection model includes the at least one probability distribution.

17. The method of claim 15, wherein each transaction record further includes (iii) a category associated with the transaction, and wherein generating the stochastic projection model comprises:
generating, based on the second subset of the transaction records, a plurality of probability distributions corresponding to a respective plurality of categories, wherein each probability distribution represents a predicted cash flow amount for the respective category over a period of time,
wherein the stochastic projection model includes the plurality of probability distributions.

18. The method of claim 15, wherein the stochastic projection model includes an artificial neural network (ANN) that includes at least one input and at least one output, the at least one input including a day of month, the at least one output including a predicted cash flow amount by the input day of month, and wherein generating the stochastic projection model comprises:
training the ANN using the second subset of the transaction records.

19. The method of claim 18, wherein the at least one input further includes a season, and wherein the method further comprises:
determining, for each of the transaction records, a season in which the transaction occurred based on the date in which the transaction occurred,
wherein the ANN is further trained using the determined seasons associated with each of the transaction records.
